(19) United States
(12) Patent Application Publication
(10) Pub. No.: US 2012/0169298 A1
(43) Pub. Date: Jul. 5, 2012

(54) SYSTEM AND METHOD FOR ELECTROCHEMICAL DEVICE WITH METAL CONTAINING IONIC LIQUID ELECTROLYTES

(75) Inventor: Jerry L. Martin, Superior, CO (US)

(73) Assignee: Boulder Ionics Corporation, Arvada, CO (US)

(21) Appl. No.: 13/339,298

(22) Filed: Dec. 28, 2011

Related U.S. Application Data
(60) Provisional application No. 61/430,166, filed on Jan. 5, 2011.

(51) Int. Cl. H02J 7/00; H01G 9/035; H01G 9/155

(52) U.S. Cl. 320/166; 361/502; 361/504

(57) ABSTRACT

Provided are a system and method for storing electrical power with an electrochemical device with a ionic liquid electrolyte having a metal coordination cation. More specifically, the device includes a positive electrode; a negative electrode; and an ionic liquid electrolyte statically disposed between the positive electrode and the negative electrode, the ionic liquid electrolyte having a metal coordination cation. The device may be structured and arranged to permit the metal in the electrolyte to undergo redox reactions such that the electrolyte functions at least in part as both an electrolyte and as an electrode. An associated method of use is also provided.

### CROSS REFERENCE TO RELATED APPLICATIONS

This application claims the benefit under 35 U.S.C. §119(e) of U.S. Provisional Application No. 61/430,166 filed Jan. 5, 2011, the disclosure of which is incorporated herein by reference.

### FIELD OF THE INVENTION

The present invention relates generally to electrical energy storage, and more specifically to an electrochemical device with metal containing ionic liquid electrolytes for electrochemical energy storage, and more specifically to ionic liquid electrolyte containing metal coordination cations.

### BACKGROUND

Electrochemical capacitors, also known as ultracapacitors or supercapacitors, include electrodes, separators and electrolytes. The energy density of a capacitor depends on the square of its voltage, so it is advantageous to operate the capacitor at the highest possible voltage consistent with maintaining good lifetime and safety.

Electrochemical capacitors generally provide lower energy density (Wh/kg) than high performance batteries, but have a response time on the order of seconds, enabling charge/discharge cycles under one minute. This makes supercapacitors ideal candidates for systems with rapidly varying loads, pulse power applications, and load leveling in regenerative systems.

The most well-developed type of electrochemical capacitor is the electric double layer capacitor (EDLC), where charge is stored in nanometer-thick electric double layers in the electrolyte adjacent to the electrodes. As the energy stored varies as the square of the operating voltage, these capacitors can be conveniently divided into three classes, based on the operating voltage and conductivity of their electrolytes. These three types are: capacitors using aqueous electrolytes, organic electrolytes and ionic liquid electrolytes.

Aqueous based electrolytes, such as sulfuric acid, have very high conductivities (up to 730 mS/cm) leading to high power densities and short response times, but are limited to voltages near 1 V. At these voltages, maximum energy densities are on the order of 1 Wh/kg. Supercapacitors with organic liquid electrolytes, such as acetonitrile (AN) or propylene carbonate (PC) can operate at up to 2.7 V/cell, enabling energy densities as high as 3-5 Wh/kg. Although these organic electrolytes enable operation over a wide temperature range (−40 to +65° C.), they are flammable, a concern for many applications. The flash point for acetonitrile is only 35° F. (2° C.). With limited voltage ranges, ultracapacitors using organic electrolytes have much lower energy densities than batteries, limiting their applications.

The maximum operating voltage is limited by the electrochemical stability window of the electrolyte. Some ionic liquids have larger electrochemical stability windows than traditional organic electrolytes and therefore can be used to make ultracapacitors with higher operating voltage and hence higher energy density. However, well-known ionic liquids like 1-ethyl-3-methyl-imidazolium bis(trifluoromethylsulfonyl)imide (EMIM TFSI), have lower conductivities than aqueous or organic electrolytes, so electrochemical devices using these electrolytes typically provide lower power than ones with higher-conductivity aqueous or organic electrolytes.

Prior art ultracapacitors using ionic liquids have achieved limited commercial success, due to limitations including the high cost of the ionic liquid, and low conductivity, particularly at low temperature.

Hence there is a need for an electrochemical device with high energy density, high power density and good performance over a wide temperature range that is capable of overcoming one or more of the above identified challenges.

### SUMMARY OF THE INVENTION

Our invention solves the problems of the prior art by providing novel systems and methods for storing electrical power and more specifically, systems and methods for an electrochemical device with metal containing ionic liquid electrolyte.

In particular, and by way of example only, according to one embodiment of the present invention, provided is an electrochemical device for storing electric power including: a positive electrode; a negative electrode; and an ionic liquid electrolyte statically disposed between the positive electrode and the negative electrode, an ionic liquid component of the electrolyte having a metal coordination cation.

In another embodiment, provided is an electrochemical device with a statically disposed ionic liquid for storing electrical power comprising: a positive electrode; a negative electrode; and a volume of ionic liquid electrolyte, the volume of ionic liquid disposed generally between the positive electrode and the negative electrode, an ionic liquid component of the electrolyte having a metal coordination cation.

In yet another embodiment, provided is a hybrid capacitor electrochemical device including: at least one electric double layer capacitive electrode and at least one second electrode; and an electroactive ionic liquid electrolyte, an ionic liquid component of the electrolyte containing a metal coordination cation therebetween.

Further, in yet another embodiment, provided is a method for storing electric power including: providing a hybrid capacitor electrochemical device including; at least one electric double layer capacitive electrode and at least one second electrode; an electroactive electrolyte containing a metal coordination cation therebetween; and operating the at least one electric double layer capacitive electrode in a voltage range where the metal in the electrolyte undergoes redox reactions.

Further still, in yet another embodiment, provided is a method for storing electric power including: providing a hybrid capacitor electrochemical device including; at least one electric double layer capacitive electrode and at least one second electrode; an electroactive electrolyte containing a metal coordination cation therebetween; and operating the at least one electric double layer capacitive electrode in a voltage range where the metal in the electrolyte does not undergo redox reactions.

### BRIEF DESCRIPTION OF THE DRAWINGS

At least one system and method for an electrochemical storage device with a ionic liquid electrolyte having a metal coordination cation for electrochemical energy storage will be described, by way of example in the detailed description below with particular reference to the accompanying drawings in which like numerals refer to like elements, and

FIG. 1 illustrates a conceptual view of a electrochemical storage device with a ionic liquid electrolyte having a metal coordination cation as a double layer capacitor device in accordance with certain embodiments of the present invention;

FIG. 2 illustrates a conceptual view of a electrochemical storage device with a ionic liquid electrolyte having a metal coordination cation device as a double layer capacitor device without a distinct separator in accordance with certain embodiments of the present invention;

FIG. 3 illustrates a conceptual view of a electrochemical storage device with a ionic liquid electrolyte having a metal coordination cation as a hybrid capacitor device in accordance with certain embodiments of the present invention;

FIG. 4 is a chemical illustration of an ionic liquid with metal coordination cation in accordance with certain embodiments of the present invention; and

FIG. 5 is a high level flow diagram of a method for storing electrical power with a electrochemical storage device with a ionic liquid electrolyte having a metal coordination cation in accordance with certain embodiments of the present invention;

### DETAILED DESCRIPTION

Before proceeding with the detailed description, it is to be appreciated that the present teaching is by way of example only, not by limitation. The concepts herein are not limited to use or application with a specific system or method for storing electrical power and more specifically for systems and methods for an electrochemical device for storing electric power, such as a double-layer capacitor with ionic liquid electrolytes. Thus although the instrumentalities described herein are for the convenience of explanation shown and described with respect to exemplary embodiments, it will be understood and appreciated that the principles herein may be applied equally in other types of systems and methods involving the storing electrical power and more specifically for systems and methods for a double-layer capacitor with ionic liquid electrolytes.

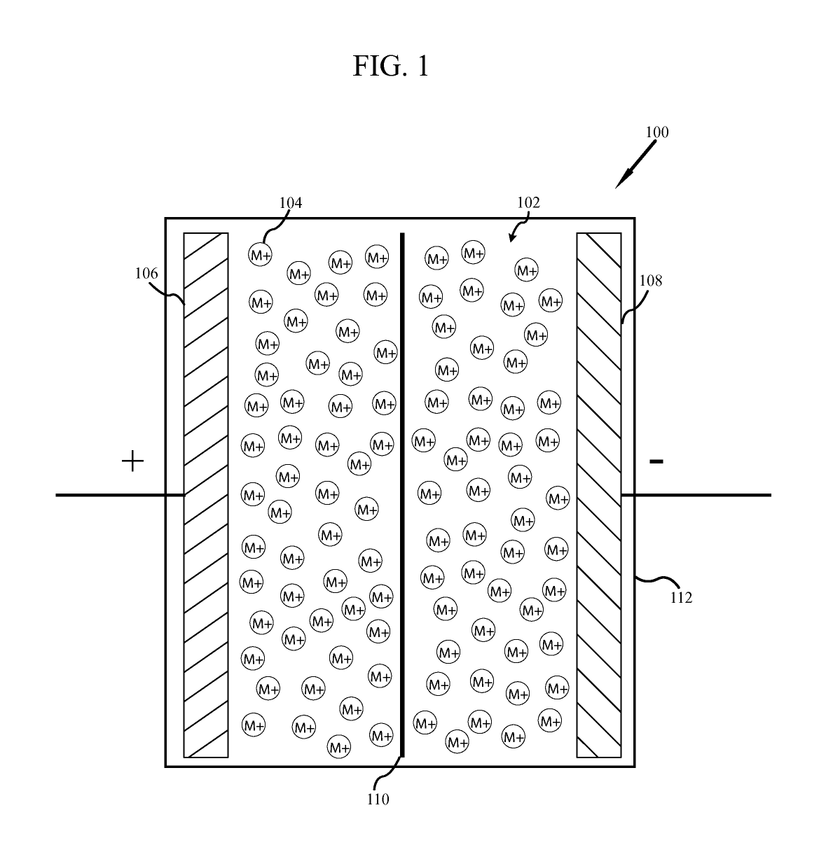

Turning now to the drawings, and more specifically FIG. 1, illustrated is an electrochemical device 100 with ionic liquid electrolyte 102 containing a metal coordination cation 104, shown as the dispersed circles with “M+” for metal cation. It is understood and appreciated that the ionic liquid electrolyte 102 also contains anions that have not been shown in the accompanying figures for ease of discussion and illustration. The device 100 has a positive electrode 106 and a negative electrode 108. A separator 110 is also shown, and may be a physical material separator 110 or in at least one embodiment a physical space.

Moreover, for at least one embodiment the metallic ionic liquid electrochemical device 100 is an electrochemical capacitor based on an ionic liquid containing a metal coordination cation. The ionic liquid electrolyte 102 is a member of a class of ionic liquids based on metal coordination cations and various anions. Some members of this family have desirable properties for use in electrochemical storage devices, including high electrical conductivity and a wide liquid temperature range.

Moreover, the embodiments of advantageous electrochemical devices 100 with ionic liquid electrolytes containing metal coordination cations herein disclosed, employ a family of ionic liquids based on metal coordination cations that have recently been disclosed and discussed with specific and limited respect to flow batteries, see T. M. Anderson, D. Ingersoll, A. J. Rose, C. L. Staiger, and J. C. Leonard, “Synthesis of an ionic liquid with an iron coordination cation,” Dalton Transactions, vol. 39, no. 37, p. 8609, 2010 and T. Anderson and D. Ingersoll, “MetILs: New Ionic Liquids for Flow Batteries,” in 2010 Update Conference—U.S. DOE Energy Storage Systems Program, 2010.

Cations and anions are both ions, the difference being the net electrical charge. An anion is an ion with more electrons then protons, giving it a net negative charge. Similarly, a cation is an ion with fewer electrons then protons, giving it a positive charge. In chemistry, a metal complex or metal coordination complex is a metal atom or ion bonded to a surrounding array of molecules or anions, which are in turn known as ligands or complexing agents. Coordination refers to the coordinate covalent bonds (dipolar bonds) between the ligands and the central atom.

A metal coordination cation is therefore formed of a metal central atom bonded to one or more ligands, with the entire complex having a positive charge. It is also appreciated that these metal coordination cation compounds are not salts as the metal central atom imparts a bonding structure that is different. Indeed the bonds of the metal complex do not involve an electron transfer as is expected in a traditional ionic bond. As such, the entire metal complex donates one or more electrons to the anion, giving the entire complex a positive charge. In varying embodiments, the metal coordination cation can have positive charges ranging from +1 to +6.

Moreover, for at least one embodiment, the metal coordination cation used for the development of the desired ionic liquid is developed based upon a fourth period metal. More specifically, for at least one embodiment the central metal atom or ion is selected from the group consisting of manganese (Mn), iron (Fe), zinc (Zn), and copper (Cu). In other embodiments, the central metal atom can be selected from the group of metals, transition metals, lanthanides or actinides.

Members of this class of ionic liquids have advantageously high conductivity not contemplated in the prior art. Specifically, members of this class of metal coordination cation ionic liquids have demonstrated electrically conductivity of 100 mS/cm as compared to the <20 mS/cm for prior art ionic liquids. High electrolyte conductivity is advantageously desirable in electrochemical devices, as it enables the manufacture of low-resistance electrical storage devices capable of high-power operation.

Members of this class of ionic liquids have been suggested for use in flow batteries, which of course require that the electrolyte flow from one storage tank through the electrochemical cell to a second storage tank, such that the system's energy capacity can be scaled independently of the power rating. Useful though they may be, the requirements of tanks, pumps and other equipment limit the applicability of flow batteries to many environments.

Embodiments of the electrochemical device 100 with ionic liquid electrolytes 102 containing metal coordination cations 104 of the present invention as presented herein do not require tanks, external to the device or incorporated as part of the device, and do not require pumps. Indeed, embodiments of the electrochemical device 100 with ionic liquid electrolytes 102 containing metal coordination cations 104 are advantageously applicable to a wide range of application environments including not only those for which a flow battery could be an option, but also many where a flow battery could not be a viable option.

Indeed with respect to FIG. 1, the electrolyte 102 containing a metal coordination cation 104 is shown disposed substantially between the electrodes 106 and 108. Moreover, although the volume of electrolyte 102 may vary from one embodiment to another, it is understood and appreciated that the volume of electrolyte 102 is disposed within the device 100 and essentially between the electrodes 106 and 108. Indeed, a case 112 enclosing device 100 generally ensures that the electrolyte 102 is statically disposed between the electrodes 106 and 108. It should also be understood and appreciated that in some embodiments, the electrodes may be comprised of porous materials, in which case the electrolyte 102 may also be present within the pores of the electrodes 106 and 108.

This is not to say that in some applications, inertia or other force cannot cause some movement of the electrolyte 102 within the device 100, but it is understood and appreciated that movement of the electrolyte 102 within device 100 is not a condition of operation as it is with a flow battery. In addition, to describe the electrolyte 102 as statically disposed between the electrodes 106 and 108 is with respect to general movement of the electrolyte 102 and not with respect to changes as may occur within the electrolyte 102 in accordance with operation of various embodiments of device 100.

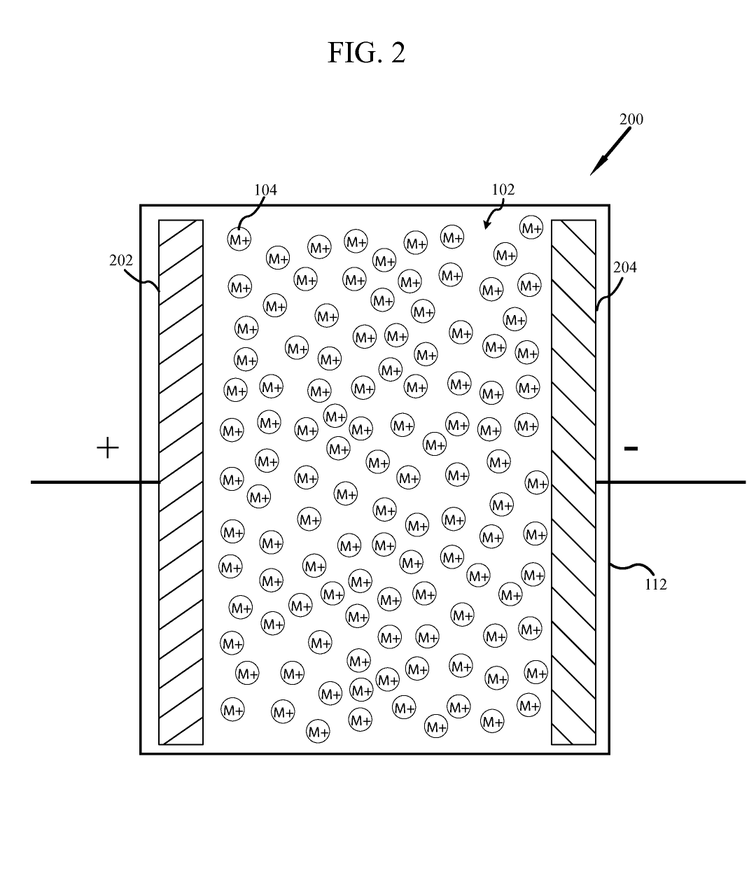

With respect to FIG. 1, it is appreciated that the device 100 as shown is an electric double layer capacitor. FIG. 2 illustrates an embodiment of the device 100 as an electric double layer capacitor 200 without an explicit separator. In addition, as is further described below, in varying embodiments the ionic liquid electrolyte may be provided in the form of various mixtures. For the double layer capacitor 200 of FIG. 2 without the explicit separator a polymer or polymer gel ionic liquid electrolyte would be advantageous as it would function both as the electrolyte and the separator.

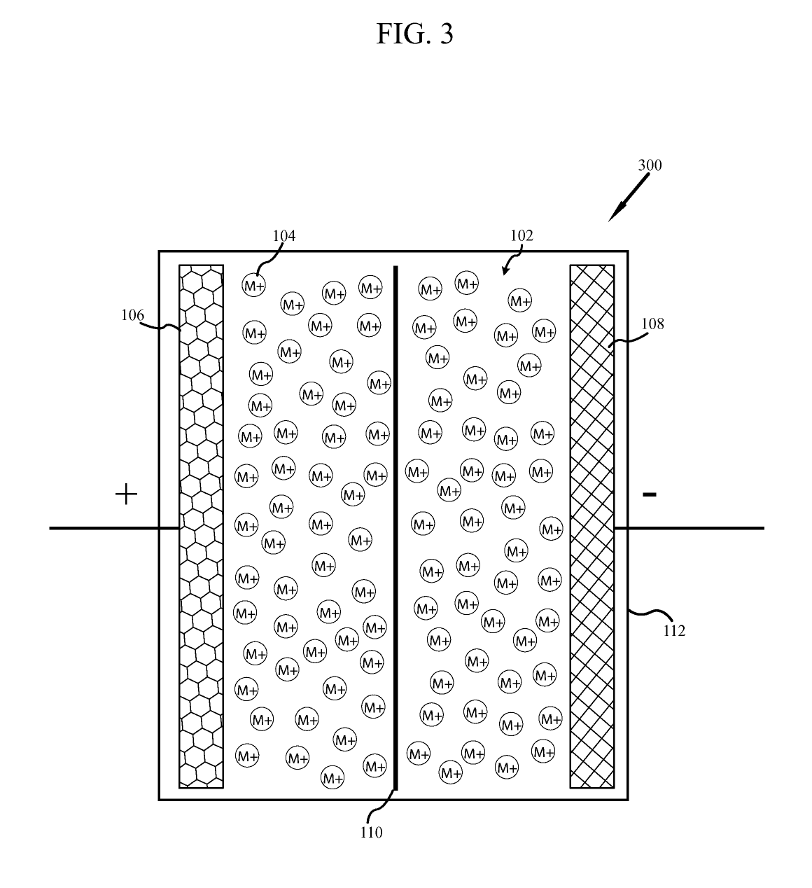

FIG. 3 is an embodiment of the device 100 as a hybrid battery-capacitor 300, wherein one electrode is a battery type electrode 302 and the other electrode is a capacitor type electrode 304. With respect to FIG. 3 as well as FIG. 1, although illustrated with two electrodes, it is understood and appreciated that embodiments of device 100 may contain multiple layers or sets of electrodes 102/106 302/304 and ionic liquid electrolyte 102.

For at least one embodiment of the electrochemical device 100 with ionic liquid electrolytes containing metal coordination cations in the electrolyte 102 containing a metal coordination cation 104 is Mn{NH(CH₂CH₂OH)₂}₆[CF₃SO₃]₂ which is obtained by mixing the solid metal salt Manganese(II) triflate Mn(CF₃SO₃)₂ with liquid diethanolamine NH(CH₂CH₂OH)₂ in a 1:6 stoichiometry. Moreover, members of this class of ionic liquids can be obtained by combining metal salts with amines, such as for example diethanolamine (DEA).

For at least one alternative embodiment of the electrochemical device 100 with ionic liquid electrolytes 102 containing metal coordination cations 104 the electrolyte 102 containing a metal coordination cation 104 is Zn{Nh₂CH₂CH₂OH}₆[CF₃SO₃]₂ which is obtained by mixing the solid metal salt zinc trifluoromethanesulfonate Zn(CF₃SO₃)₂ with liquid NH(CH₂CH₂OH)₂ in a 1:6 stoichiometry.

For yet other alternative embodiment the electrochemical devices 100 with ionic liquid electrolytes 102 containing metal coordination cations 104 the electrolyte 102 containing a metal coordination cation 104 is Cu{NH₂CH₂CH₂OH}₆[CH₃(CH₂)₃CH(C₂H₅)CO₂]₂ or Cu{NH(CH₂CH₂OH)₂}₆[CH₃(CH₂)₃CH(C₂H₅)CO₂]₂ respectively obtained by mixing the solid metal salt Copper(II) ethylhexanoate Cu(CH₃(CH₂)₃CH(C₂H₅)CO₂)₂ with liquid NH(CH₂CH₂OH)₂ or NH₂CH₂CH₂OH in a 1:6 stoichiometry.

Further, for at least one alternative embodiment of the electrochemical device 100 with ionic liquid electrolytes 102 containing metal coordination cations 104 the electrolyte 102 containing a metal coordination cation 104 is Cu{NH(CH₂CH₂OH)₂}₆[(CF₃SO₂)₂N]₂ obtained by mixing the solid metal salt Cu(CF₃SO₂)₂N)₂ with liquid diethanolamine NH(CH₂CH₂OH)₂ in a 1:6 stoichiometry.

Further still, for at least one alternative embodiment of the electrochemical device 100 with ionic liquid electrolytes 102 containing metal coordination cations 104 the electrolyte 102 containing a metal coordination cation 104 is Cu{NH(CH₂CH₂OH)₂}₆[CF₃SO₃]₂ obtained by mixing the solid metal salt Cu(CF₃SO₃)₂ with liquid diethanolamine NH(CH₂CH₂OH)₂ in a 1:6 stoichiometry.

Yet further, for at least one alternative embodiment of the electrochemical device 100 with ionic liquid electrolytes 102 containing metal coordination cations 104 the electrolyte 102 containing a metal coordination cation 104 is Fe{(OHCH₂CH₂)₂NH}₆[CF₃SO₃]₃ which is obtained by mixing the solid metal salt Fe(CF₃SO₃)₃ with liquid NH(CH₂CH₂OH)₂ in a 1:6 stoichiometry.

Moreover, the ionic liquid electrolyte 102 of the electrochemical device 100 with ionic liquid electrolytes containing metal coordination cations in the electrolyte 102 is advantageously obtained by mixing metal salts with amines.

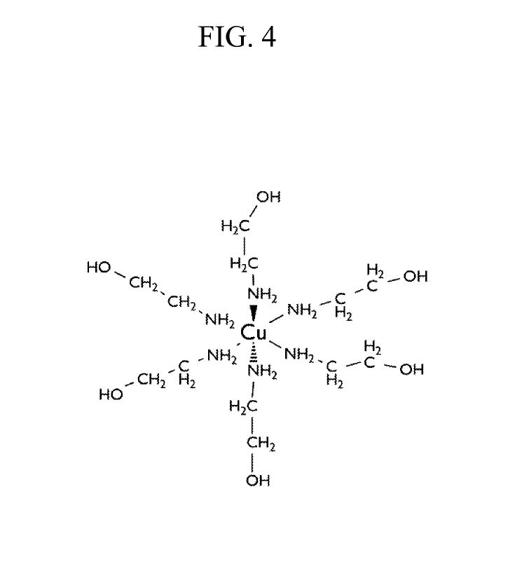

FIG. 4 illustrates the ionic liquid electrolyte 102 containing a metal coordination cation 140 corresponding to Cu{NH(CH₂CH₂OH)₂}₆[CH₃(CH₂)₃CH(C₂H₅)CO₂]₂ as described above. Members of this class of ionic liquids not only have advantageously high conductivity not contemplated in the prior art as noted above, but have also demonstrated an advantageously increased operating ranges from about −84° C. to about 290° C. Moreover, adaptive selection of ionic liquid electrolytes 102 containing metal coordination cations 104 permits development of devices 100 tailored for specific environments not presently provided for by ionic liquids not containing the metal coordination cations, and mixtures of these ionic liquids can permit development of devices 100 tailored for operation in an increased range of environments not presently provided by existing electrolytes.

Yet another advantage of the electrolyte 102 containing a metal coordination cation is the ability to undergo quasi-reversible oxidation and reduction. Moreover, for at least one embodiment the device 100 is structured and arranged with the metal in the electrolyte 102 undergoes a redox reaction. Therefore one aspect of this invention is the use of these ionic liquids in a hybrid capacitor where the electrolyte can be an active element in the hybrid capacitor.

Indeed, the electrochemical device 100 with ionic liquid electrolytes containing metal coordination cations is advantageously a new class of electrochemical storage device as the electrolyte with the metal coordination cation serves a dual purpose. This electrolyte 102 functions as both an electrolyte as well as an electrode as it both conducts ions and participates in the electrochemical reactions. Combining these functions advantageously permits slimmer and or less expensive power source devices.

Returning to the hybrid-capacitor 300 embodiment of the device 100 shown in FIG. 3, in at least one embodiment of such a device, at least one electrode is a double-layer capacitive electrode, e.g., electrode 302. The other electrode 304 is a battery-type electrode may be designed to participate in reactions with the electrolyte 102, adding additional capacity. For at least one embodiment of device 100, electrode 304 is a Faradic electrode.

Alternately, in yet another embodiment, both electrodes 302 and 304 can be capacitive, and the electrolyte 102 itself may undergo redox reactions.

This hybrid nature is potentially highly advantageous for it is well known that current Electric Double Layer Capacitors (EDLCs) are specifically and very intentionally designed so that the electrolyte does not undergo any chemical reactions or electrochemical reactions with either electrode. Moreover, for a traditional EDLC the electrolyte is not reduced or oxidized in normal operation. Often warnings are provided regarding EDLCs to caution against attempting to operate the devices in voltage or temperature ranges where electrochemical reactions with the electrolyte would occur.

In short, traditional EDLCs specifically teach away from operating under conditions where the electrolyte can be reduced or oxidized. Embodiments of the device 100 as a hybrid-capacitor 300 as set forth herein advantageously overcome these issues. Moreover, permitting embodiments of device 100 to incorporate electroactive electrolyte 102 allows for higher power or lower cost devices, as the solid electrodes can be replaced with liquid electrode/electrolyte combinations that respond more quickly.

With respect to the embodiments of device 100 herein described, it is understood and appreciated that for at least one embodiment the electrolyte 102 is a pure ionic liquid. For at least one alternative embodiment, the electrolyte 102 may be a mixture of ionic liquids. And, for yet other alternative embodiments, the ionic may be a mixture of the ionic liquid with a solvent. In addition, a salt may be added to the ionic liquid or ionic liquid/solvent solution as is well known by those skilled in the art of batteries and battery-capacitor hybrids. Further, for at least one embodiment, the electrolyte 102 may be polymer, polymer gel or combination thereof including at least one ionic liquid having a metal coordination cation.

Alternatively, by choosing an ionic liquid with a metal that does not undergo oxidation or reduction in the operating voltage range of the device, the capacitor will function as a pure EDLC (Electric Double Layer Capacitor). In this embodiment, the ionic liquid is used for its desirable properties of conductivity, wide temperature range and large voltage window.

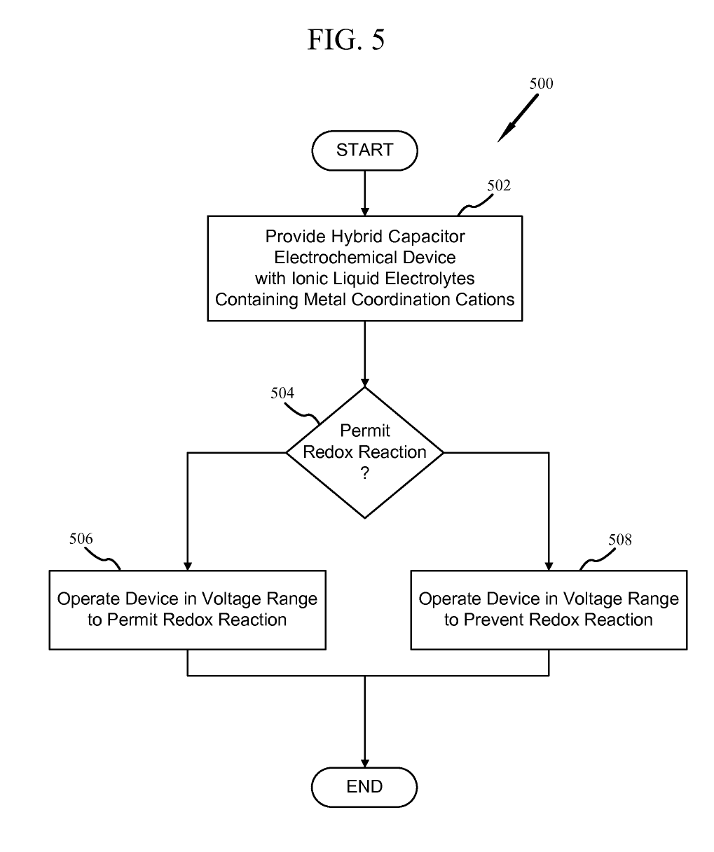

FIG. 5 conceptually illustrates a high level flow diagram depicting at least one method 500 for storing electrical power with at least one embodiment of a device 100. It will be understood and appreciated that the described method need not be performed in the order in which it is herein described, but that this description is merely exemplary of one method for storing electrical power with a device 100.

At a high level, method 500 may be summarized as follows. For the illustrated example, method 500 commenced by providing a hybrid capacitor electrochemical device (such as an embodiment of the device 100 in FIG. 1 or the device 300 in FIG. 3, block 502. For at least one embodiment, this hybrid capacitor device is substantially equivalent to hybrid-capacitor 300, e.g., having at least one double layer capacitive electrode and at least one second electrode and an electroactive electrolyte containing a metal coordination cation disposed substantially therebetween the electrodes.

As noted above, the advantageous properties of the metal based electrolyte 102 permit different embodiments of the device 100 to advantageously operate with or without redox reactions. As such, for at least one embodiment, where it is desired to permit a redox reaction, decision 504, the double layer capacitive electrode is operated in a voltage range where the metal in the electrolyte 102 undergoes redox reactions, block 506. For at least one alternative embodiment where it is desired not to permit a redox reaction, decision 504, the double layer capacitive electrode is operated in a voltage range where the metal in the electrolyte 102 does not undergo redox reactions, block 508.

Of course the environment for application will likely dictate the choice of ionic liquid electrolyte 102 and a determination of whether or not to structure and arrange the device 100 to permit redox reaction, for as note this new advantageous ability permits the development of a new class electrochemical storage device as the electrolyte with the metal coordination cation serves as both an electrolyte as well as an electrode, permitting slimmer, smaller and or less expensive devices 100.

Changes may be made in the above methods, systems and structures without departing from the scope hereof. It should thus be noted that the matter contained in the above description and/or shown in the accompanying drawings should be interpreted as illustrative and not in a limiting sense. Indeed many other embodiments are feasible and possible, as will be evident to one of ordinary skill in the art. The claims that follow are not limited by or to the embodiments discussed herein, but are limited solely by their terms and the Doctrine of Equivalents.

What is claimed is:

1. An electrochemical device for storing electric power comprising:
a positive electrode;
a negative electrode; and
an ionic liquid electrolyte statically disposed between the positive electrode and the negative electrode, an ionic liquid component of the electrolyte having a metal coordination cation.

2. The electrochemical device of claim 1, wherein the device is an electric double layer capacitor.

3. The electrochemical device of claim 1, wherein the device is a hybrid battery-capacitor with at least one battery-type electrode and at least one electrochemical double layer electrode.

4. The electrochemical device of claim 1, wherein the ionic liquid component is synthesized by mixing a metal salt with an amine.

5. The electrochemical device of claim 1, wherein the ionic liquid electrolyte is selected from the group consisting of, a pure ionic liquid having a metal coordination cation, a mixture of ionic liquids at least one ionic liquid having a metal coordination cation, a mixture of an ionic liquid having a metal coordination cation with a solvent.

6. The electrochemical device of claim 1, wherein the ionic liquid electrolyte is a polymer or polymer gel.

7. The electrochemical device of claim 5, the ionic liquid electrolyte further including a salt.

8. The electrochemical device of claim 1, wherein the ionic liquid electrolyte is Mn{NH(CH₂CH₂OH)₂}₆[CF₃SO₃]₂.

9. The electrochemical device of claim 1, wherein the ionic liquid electrolyte is selected from the group consisting of:
Zn{NH₂CH₂CH₂OH}₆[CF₃SO₃]₂,
Fe{(OHCH₂CH₂)₂NH}₆[CF₃SO₃]₃,
Cu{NH₂CH₂CH₂OH}₆[^{CH}₃CH₂)₃CH(C₂^{H}₅)CO₂]₂,
Cu{NH(CH₂CH₂OH)₂}₆[CH₃(CH₂)₃CH(C₂H₅)CO₂]₂,
Cu{NH(CH₂CH₂OH)₂}₆[CF₃SO₃]₂, and
Cu{NH(CH₂CH₂OH)₂}₆[(CF₃SO₂)₂N]₂.

10. An electrochemical device with a statically disposed ionic liquid for storing electrical power comprising:
a positive electrode;
a negative electrode; and
a volume of ionic liquid electrolyte, the volume of ionic liquid disposed generally between the positive electrode and the negative electrode, an ionic liquid component of the electrolyte having a metal coordination cation.

11. The electrochemical device of claim 10, wherein the device is an electric double layer capacitor.

12. The electrochemical device of claim 10, wherein the device is a hybrid battery-capacitor with at least one battery-type electrode and at least one electrochemical double layer electrode.

13. The electrochemical device of claim 10, wherein the ionic liquid electrolyte is selected from the group consisting of, a pure ionic liquid having a metal coordination cation, a mixture of ionic liquids at least one ionic liquid having a metal coordination cation, a mixture of an ionic liquid having a metal coordination cation with a solvent.

14. The electrochemical device of claim 10, wherein the ionic liquid electrolyte is a polymer or polymer gel.

15. The electrochemical device of claim 10, wherein the device has an operating range of about −84° C. to about 290° C.

16. The electrochemical device of claim 10, wherein the device is structured and arranged to operate in a predefined voltage range wherein the metal in the electrolyte undergoes redox reactions.

17. The electrochemical device of claim 10, wherein the ionic liquid component is synthesized by mixing a metal salt with an amine.

18. A hybrid capacitor electrochemical device comprising:
at least one electric double layer capacitive electrode and at least one second electrode; and
an electro active ionic liquid electrolyte, an ionic liquid component of the electrolyte containing a metal coordination cation therebetween.

19. The hybrid capacitor electrochemical device of claim 18, wherein the at least one second electrode is structured and arranged to participate in redox reactions with the electrolyte.

20. The hybrid capacitor electrochemical device of claim 18, wherein the at least one second electrode is structured and arranged to participate in electrochemical reactions with the electrolyte.

21. The hybrid capacitor electrochemical device of claim 18, wherein the device is structured and arranged to operate in a voltage range where the metal in the electrolyte undergoes redox reactions.

22. The hybrid capacitor electrochemical device of claim 18, wherein the device is structured and arranged to operate in a voltage range where the metal in the electrolyte does not undergo redox reactions.

23. The hybrid capacitor electrochemical device of claim 18, wherein at least one second electrode is a Faradic electrode.

24. The hybrid capacitor electrochemical device of claim 18, wherein the ionic liquid component is synthesized by mixing a metal salt with an amine.

25. A method for storing electric power comprising:
providing a hybrid capacitor electrochemical device including;
at least one electric double layer capacitive electrode and at least one second electrode;
an electroactive electrolyte containing a metal coordination cation therebetween; and
operating the at least one electric double layer capacitive electrode in a voltage range where the metal in the electrolyte undergoes redox reactions.

26. The method of claim 25, wherein the ionic liquid electrolyte is selected from the group consisting of, a pure ionic liquid having a metal coordination cation, a mixture of ionic liquids at least one ionic liquid having a metal coordination cation, a mixture of an ionic liquid having a metal coordination cation with a solvent.

27. The method of claim 25, wherein the ionic liquid electrolyte is Mn{NH(CH₂CH₂OH)₂}₆[CF₃SO₃]₂.

28. A method for storing electric power comprising:
providing a hybrid capacitor electrochemical device including;
at least one electric double layer capacitive electrode and at least one second electrode;
an electroactive electrolyte containing a metal coordination cation therebetween; and
operating the at least one electric double layer capacitive electrode in a voltage range where the metal in the electrolyte does not undergo redox reactions.

29. The method of claim 28, wherein the ionic liquid electrolyte is selected from the group consisting of, a pure ionic liquid having a metal coordination cation, a mixture of ionic liquids at least one ionic liquid having a metal coordination cation, a mixture of an ionic liquid having a metal coordination cation with a solvent.

30. The method of claim 28, wherein the ionic liquid electrolyte is Mn{NH(CH₂CH₂OH)₂}₆[CF₃SO₃]₂.
